(19) United States
(12) Patent Application Publication
(10) Pub. No.: US 2013/0239792 A1
(43) Pub. Date: Sep. 19, 2013

(54) Method For The Production Of Highly Oriented Polyolefin Ribbons, Textiles And Technical Flexible Sheet Materials Produced Therefrom, And The Use Thereof In Protective Bodies For The Protection From Ballistic Projectiles And The Like

(71) Applicant: NEXTRUSION GMBH, Bobingen (DE)

(72) Inventors: Hans-Joachim Bruning, Augsburg (DE); Andreas Fischer, Bobingen (DE); Jan Adolph Dam Backer, WN Son (NL); Mark James Bonner, Leeds (GB); Ian McMillan Ward, Leeds (GB)

(73) Assignee: NEXTRUSION GMBH, Bobingen (DE)

(21) Appl. No.: 13/774,997

(22) Filed: Feb. 22, 2013

Related U.S. Application Data
(63) Continuation of application No. 12/594,474, filed on Oct. 2, 2009, now abandoned.

(30) Foreign Application Priority Data
Apr. 12, 2007 (DE) 102007017621.1

(51) Int. Cl. F41H 5/02; B32B 5/02; B32B 5/12

(52) U.S. Cl. CPC F41H 5/02; B32B 5/12; B32B 5/024; B32B 5/028
USPC 89/36.01; 526/352; 526/351; 264/146; 156/148; 442/1

(57) ABSTRACT

The invention relates to a method for the production of high-strength ribbons having a high modulus of elasticity made of a highly molecular polyolefin, wherein the polyolefins, particularly polypropylene and polyethylene, are extruded through a slotted nozzle, are then subjected to a temperature of 85° to 135° C. for a duration of at least one second, the films are then cut into individual ribbons, if necessary, and stretched at temperatures between 90° and 165° C. in one or more steps, are rolled up or further processed directly into textiles or technical flexible sheet materials. The ribbons can be laminated into multi-layer flexible sheet materials by using adhesives or adhesion promoters, the flexible sheet materials being particularly suitable as protection from ballistic projectiles. In this case particularly in the form of plate-shaped or flexible compound bodies.

This application is a Continuation of U.S. application Ser. No. 12/594,474, filed Oct. 2, 2009, which is the U.S. National Stage of International Application No. PCT/EP2008/002887, filed Apr. 11, 2008, which designates the U.S., published in German, and claims priority under 35 U.S.C. §§119 or 365(c) to German Application No. 10 2007 017 621.1, filed Apr. 12, 2007.

The invention relates to a method of producing high-strength ribbons having a high modulus from polyolefin of high molecular weight, to ribbons which are produced by a method of this kind, and to textile or engineering sheet materials produced therefrom and to the use of the latter in shaped or plate-like composite bodies for providing protection against ballistic projectiles such as bullets from pistols, rifles, etc., and also against shrapnel and the like which may strike the body of a human at the time of explosions or shell impacts, etc., and which may thus cause injuries to him or may even have a fatal effect.

It is known for polyolefin to be processed into monofilaments by pressing it through dies when in molten form by means of extruders. The exit opening of the die is generally circular in outline in this case. What are also known however are dies having cross-sectional shapes which differ from those of dies of circular cross-section and which have for example cross-sections of angular shapes, half-moon cross-sections, trilobed cross-sections, and so on,

Also known are wide slit dies and dies which can be used to produce flat films or tubular films for example.

Also known is the production of tapes (ribbons) or split yarns from polyolefin material of high molecular weight. In this way, Canadian patent 2166312 for example describes a method in which an ultra-high-molecular-weight polyethylene film or film-like material is first rolled, this film-like material having a film of thermoplastic plastics material laminated onto it on the upper side and/or underside, which thermoplastic film contains a colouring agent, a weathering stabilizer, an antistatic agent, a hydrophilizing agent, an adhesion agent or a dyeability-imparting agent.

The film-like material comprising two or more layers is then stretched and slit to an appropriate width or split into split yarns. Under the teaching of this Canadian patent, the film of ultra-high-molecular-weight polyethylene which acts as the starting material is preferably produced by compressing suitable polyethylene powder. While it is also specified that this high-molecular-weight polyethylene can be processed into a film by extrusion there are absolutely no detailed directions as to how this is to be done.

Nor does this Canadian patent contain any hints of the use of the yarns or fine ribbons produced under its teaching to produce bodies which are intended to be used to provide protection against ballistic projectiles and the like

Tapes, ribbons and line products such as monofilaments of high molecular weight polyethylene are described in U.S. Pat. No. 5,479,952. However, it is apparent from the discussion of the prior art in this American patent how complicated and difficult it is to produce tapes of this kind. It is true that an indication is given in it of the possibility of tapes being produced by melt extrusion and of these then being stretched. However, there is a total absence of any exact details in this specification, especially relating to the process parameters, and instead what is disclosed as the teaching of this patent is a method in which a tape, which forms a precursor material and has been produced by, in particular, the compression of powder, is brought to a pseudo-gel state using a non-volatile solvent, the non-solvent is removed by compression and by extraction with a volatile solvent, and the intermediate product which has been obtained in this way is then rolled and afterwards stretched.

A method of this kind is of course very cumbersome and time-consuming. The tapes which are obtained in this way are suitable in particular for use as dental floss but are also recommended for many other applications such as fishing line, filaments for sailcloth, porous membranes, reinforcing materials, catheters and balloon materials and, in combination with glass, carbon, steel, boron nitride, and so on, for articles having good impact resistance and for bulletproof and ballistic resistant material. There are however no exact details whatever as to how such products are to be produced.

A method of producing high-strength polyethylene fibres is described in U.S. Pat. No. 4,228,119. The teaching of this American patent is confined to the spinning of high-density polyethylene with a number average molecular weight Mn of at least 20,000 and a weight average molecular weight Mw of less than 125,000. Various details relating to the spinning and stretching process are given in it; amongst other things, what is also disclosed is the use of a heating tube downstream of the spinning die. However, after leaving this heating tube the filament is quenched, preferably in air at ambient temperature.

There are no hints in this document of ribbons or tapes being produced nor are any indications given that the fibres, filaments or yarns described in it can be used for the production of articles which are intended to act as a means of protection against projectiles.

In EP 0 766 460 A2 is described a method of producing high-strength yarns in which a film is stretched transversely in the melted or solid state. The aim of this European patent application is to produce films having a mesh-like structure as is the case with so-called split fibres or split yarns. From these yarns, non-woven materials are then produced in which individual non-woven materials are connected to form a stronger non-woven material by being laid on top of one another crosswise.

However, a method such as the invention discloses and products according to the invention are neither disclosed nor made obvious in this European patent application.

What is more, there are also numerous scientific publications which are concerned with a vast variety of aspects of the processing of polyolefins, including in particular polyethylene and polypropylene, but none of them disclose a usable method which can be put to use industrially and which, starting from the polymer, can be carried out easily through to the finished product. No clear, unambiguous, and complete proposals which can be followed in practice are made for a method, and in particular for a continuous method such as the invention teaches.

Taweechai Amornsakchai et al. (in Development of high strength polyethylene fiber from local materials for ballistic applications: paper read during the “4^{th} Thailand Materials Science Technology Conference” 2006) presented thoughts on the development of high strength polyethylene fibre from local materials for ballistic applications. A method such as the invention discloses was not taught by them either. In this way, there are no hints whatever of the ribbons being exposed to a temperature from 85° to 135° C. before they are stretched. This being the case, this is another publication in which the average person skilled in the art is unable to find a method such as the invention teaches.

Although numerous methods of producing high-strength polyolefin ribbons, and in particular polypropylene and polyethylene ribbons, are known, there is still a need for improved methods and for corresponding ribbons and for products which contain these ribbons.

It is therefore an object of the invention to make available a method of producing high-strength ribbons having a high modulus of elasticity from polyolefins of high molecular weight, and in particular polypropylene and polyethylene, which can be performed easily and quickly and which results directly in commercially viable ribbons, tapes and textile sheet materials and also composite bodies which can be used in particular to provide protection against ballistic projectiles or against shrapnel such as may be produced in explosions or by shells.

It is also an object of the invention to make available a method in which the properties of polyethylene and polypropylene with regard to strength, stretchability and modulus of elasticity can be exploited in an optimum way and developed.

These objects are achieved by a method of producing high-strength ribbons having a high modulus of elasticity from polyolefin of high molecular weight which is characterised in that the polyolefin is extruded through a slit die as a melt whose temperature is at least 10° C. above the melting point of the polyolefin, the emerging film, which is still in the melted state, is exposed to a temperature from 85° to 135° C. for a period of at least one second by means of a tempering zone, the film is cut into individual ribbons if required and is then stretched in one or more stages at temperatures of between 90° C. and 165° C. until a total stretch of 15:1 to 60:1 is reached, and the ribbons are wound into reels or further-processed directly into textile or engineering sheet materials.

A thickness from 10 μm to 250 μm, and in particular 30 μm to 80 μm, is preferably set for the ribbons by setting the height of the slit, the feed rate and the total stretch.

It is advantageous for the film to be cut into ribbons of widths from 5 to 50 mm, and in particular from 7 to 20 mm, before being stretched.

In a particularly advantageous embodiment, the ribbons are perforated by means of a needle roller after being stretched.

The exposure of the films to a temperature from 85° to 135° C. is preferably performed by passing them over one or more cooling rollers which are at a temperature from 85° to 135° C.

In a further advantageous embodiment of the method according to the invention, the exposure to a temperature from 85° to 135° C. is performed by passing the film through a liquid or a gas, and preferably an inert gas, at a temperature from 100 to 135° C.

The polyolefins used may contain normal additives and in particular, and preferably, 0.01 to 5% by weight of calcium carbonate and/or 0.01 to 5% by weight of a UV-stabiliser and/or 0.01 to 5% by weight of a thermal stabiliser or 0.1 to 5% by weight of a polyararnide powder.

Polyaramides are polyamides, also known as aramides, based on aromatic diamines such as p-phenyl diamine and aromatic dicarboxylic acids such as terephthalic acid.

The additives used may be used alone or in mixtures, the total amount of the additives preferably not being more than 5% by weight.

The polyolefin of high molecular weight which is used is, in the case of a polyethylene of high molecular weight, preferably a polyethylene having average molecular weights Mw from 80,000 to 500,000 and Mn from 5,000 to 80,000 and, in the case of a polypropylene of high molecular weight, a polypropylene having average molecular weights Mw from 100,000 to 130,000 and Mn from 25,000 to 33,000.

In a particular embodiment of the method according to the invention, the film, on leaving the slit die, is passed directly through a heating zone which is at a temperature from 135° C. to the temperature of the melting point of the polymer being extruded, before it is exposed to a temperature from 85° to 135° C. for a period of at least one second.

It is advantageous for a bimodal polyolefin to be used.

The invention also relates to ribbons, produced by a method as specified above, which are characterised in that they are of a strength from 500 MPa to 3000 MPa and have a modulus of elasticity from 20 GPa to 180 GPa, the modulus of elasticity being determined from the secant which intersects the stress-strain curve of the ribbon, measured at an ambient temperature of 23° C. and a relative humidity of 65%, at a strain of between 0.5% and 1%.

The invention also relates to a method of producing textile and engineering sheet materials which contain fine ribbons of the kind described above, which method is characterised in that the ribbons are provided on one or more sides with an adhesive and/or an adhesion promoter and are then connected by lamination to fowl sheet materials having two or more layers.

Preferably the ribbons are worked up into the multilayered sheet materials as laid scrims or woven fabrics.

The multilayered sheet materials according to the invention can be used with particular advantage as laminates in plate-like or flexible composite bodies for producing protective bodies for providing protection against ballistic projectiles.

The method according to the invention may for example be performed as follows.

The polyolefin, such as polypropylene or polyethylene, is placed in an extruder and melted there and when this is done is heated to a temperature which is at least 10° C. above the melting point of the polyolefin used but which is preferably at least 50° C., thus causing the viscosity of the melt produced to reach values which make it possible for the melt to be extruded smoothly through the slit die.

What have proved particularly satisfactory in the case of polyethylene are types whose melt flow rates (MFR under ISO 1133 (190° C./2.16 kg)) are between 0.3 and 1.5 g/10 min. What have proved particularly satisfactory in the case of polypropylene are types whose melt flow rates (MFR under ISO 1133 (190° C./2.16 kg)) are between 1.0 and 3 g/10 min.

The molecular weights were determined by known methods, namely the gel permeation chromatography (GPC) method. What was used for this was a GP220 apparatus made by Polymer Laboratories; columns of pigel guard plus 2× mixed bed-B,, 30 cm, 10 μm were used. The solvent used was 1,2,4-trichlorobenzene containing an antioxidant. The flow rate was 1.0 ml/min. The temperature was 160° and what was used as the detector was the refractive index.

What may be used as dies are normal slit dies including wide slit dies whose width may range from 300 mm to 2800 mm.

On leaving the die, the film, which is still in the melt state, is guided through a tempering zone which serves to even out the structure of the melt. This has a beneficial effect in particular on the crystallisation which then takes place.

In the tempering zone, the film is exposed to a temperature from 85° to 135° C. for at least one second. In this zone, advantageous crystallisation of the polymer takes place. The crystallisation can best be followed from the opacification of the film.

The interaction with the tempering and treatment at a temperature from 85° to 135° C. creates pre-conditions favourable to stretchability and hence for the achieving of excellent mechanical properties such as strength and modulus of elasticity.

After the treatment at a temperature from 85° to 135° C., the ribbons are stretched in one or more stages at temperatures from 90 to 165° C., what is meant in this case by total stretching being the sum of the amounts of stretch in the individual stages of stretching and of the so-called spinline strain which may possibly exist. What spinline strain is to be understood to mean is the difference between the exit speed from the die and the speed at which the ribbons leave the 85° to 135° C. zone.

In accordance with the invention, it is possible for the properties of the ribbons obtained to be acted on by varying on the one hand the spinline strain and on the other hand the subsequent stretches.

After being stretched, the ribbons may be cut to a smaller width, e.g. to widths of a minimum of 0.6 mm or up to 50 mm. It is however also possible for the ribbon to be left at its original width of for example 50 cm or 1 m. The ribbons may then be either wound into reels and fed to means of further processing at a later point in time. They may however also be fed directly to the means of further processing.

In a particular embodiment of the invention, the ribbons are perforated by means of a needle roller after being stretched.

The perforating is advantageously performed particularly with ribbons of fairly considerable width because by this means they are also given, amongst other things, particular flexibility and prove to be very advantageous in textile or engineering sheet materials. The fine ribbons, and particularly those of quite narrow widths, may very advantageously be further processed into textile or engineering sheet materials, and in particular into woven fabrics and laid scrims.

These woven fabrics or laid scrims may then advantageously be laminated to form multi-layered sheet materials, it being advantageous for the individual layers to be provided with an adhesive and/or an adhesion promoter on one or more than one sides and then to be combined into a composite body by lamination.

It goes without saying that, as well as the woven fabrics or laid scrims, the composite body may also include other media, such for example as plastic plastics materials or thermosets, thus enabling composite bodies in plate form which are notable for their particular stiffness, or even flexible composite materials, to be obtained if required. What are used as adhesives or adhesion-promoting systems are, in particular, media whose melting point is 5 to 30° C. below the melting point of the polymer which was used to produce the ribbons.

The invention will be explained by reference to two examples, and the details can be seen from the Table.

TABLE

| | Production date | | | | |
|---|---|---|---|---|---|
| | Time | | Polyethylene | | |
| | Setting | | E41-1 | Temperature | PP |
| Extruder | Zone 1 | ° C. | | 230.0 | 240 |
| | Zone 2 | ° C. | | 230.0 | 245 |
| | Zone 3 | ° C. | | 230.0 | 250 |
| | Zone 4 | ° C. | | 230.0 | 250 |
| | Die ° C. | ° C. | | 230.0 | 260 |
| Cooling roller | Cooling roller | ° C. ° C. | | 114 | 88 |
| | Cooling roller | m/min m/min | 1.4 | | 1.2 |
| | | | Multi-stage at | 105-124° C. | 120-140° C. |
| | Stretch | | temperatures of | | |
| Exit septet | At exit | m/min | 67.0 | | 36 |
| | Total stretch | 1: | 47.9 | | 30.0 |
| | Titre | dtex | 1001 | | 1050 |
| | Strength | cN/tex | 107.04 | | 120.2 |
| | Elongation at rupture | % | 1.9 | | 5.5 |
| | Modulus of elasticity | N/tex | 79.85 | | 31.3 |

It was particularly surprising that it was possible, by means of the invention, for excellent ribbons to be produced from polypropylene and polyethylene. The method according to the invention can be performed all in one piece, i.e. uninterruptedly from the polymer to the finished ribbon, and it operates without any complications and is fast and repeatable. The textile or engineering sheet materials produced from the ribbons are notable for having excellent properties and are suitable in particular as bodies for providing protection against ballistic projectiles. There are therefore used in particular in the production of protective garments and also in the production of composite bodies in plate form which can also be used as building materials for structures which are made safe.

What are particularly advantageous are textile and engineering composite materials which comprise a plurality of layers of a woven fabric or a laid scrim.

When for example woven fabrics are used to produce multi-layered composite bodies, what this means is that, for example, a layer of woven fabric lies with the direction of the warp filaments in the longitudinal direction, and the warp filaments of the next layer are at an angle of, for example, at least 10° to the warp filaments of the layer situated below it or above it. It is possible in this way to obtain composite bodies or textile laminates which are particularly suitable for intercepting and arresting projectiles because the absorption of energy is particularly high in these composite bodies, i.e. the bullet is braked to a halt with a corresponding speed and sharpness.

It is also possible for angles of up to 90° to be selected. One or more layers in which the warp filaments for example, i.e. the ribbons forming the warp, lie in the longitudinal direction may be combined with woven fabrics whose warp filaments are at an angle to the warp filaments of the woven fabrics in which the warp filaments are longitudinally orientated. For this purpose, it is possible on the one hand for webs which extend longitudinally to be covered with portions in which the warp filaments are at an angle from 10 to 90° to the longitudinal web.

It was particularly surprising that, with the help of the invention polyolefin of the range of molecular weights from 80,000 to 500,000 in the case of polyethylene and of the corresponding range for polypropylene, ribbons are obtained which are of a strength of more than 1 GPa and which have low elongations at rupture in the range of 2-6. The ribbons can be produced at high speeds, exit speeds of up to 250 m/min being possible, and this is possible all in one go, i.e. from the die to the speed of the last stretching roller, which latter speed can then be taken as the speed for winding into reels.

Total stretches from 1:15 to 1:60 are possible as are moduluses of elasticity of 20-120 GPa. In the case of conventional fine polyolefin ribbons which are in the lower range of molecular weights, the modulus of elasticity is a maximum of 20 GPa and the stretch is usually up to a maximum of 1:20. In the gel spinning of polyolefins of ultra-high molecular weight or in the compacting process in which powders are compressed, the maximum exit speed at which operations can take place is 60 m/min.

What is claimed is:

1. Method of producing high-strength ribbons having a high modulus of elasticity from polyolefin of high molecular weight, characterised in that the polyolefin is extruded through a slit die as a melt whose temperature is at least 10° C. above the melting point of the polyolefin, the emerging film, which is still in the melted state, is then exposed to a temperature from 85° to 135° C. for a period of at least one second, the film is then cut into individual ribbons if required and is then stretched in one or more stages at temperatures of between 90° C. and 165° C. until a total stretch of 15:1 to 60:1 is reached, and the ribbons are wound into reels or further processed directly into textile or engineering sheet materials.

2. Method according to claim 1, characterised in that a thickness from 10 μm to 250 μm is set for the ribbons by setting the height of the slot, the feed rate and the total stretch.

3. Method according to claim 2, characterised in that a thickness from 30 μm to 80 μm is set for the films.

4. Method according to claim 1, characterised in that the films are cut to a width from 0.6 to 50 mm before being stretched.

5. Method according to claim 4, characterised in that the ribbons are cut to a width from 5 to 20 mm.

6. Method according to claim 1, characterised in that the film is perforated by means of a needle roller after being stretched.

7. Method according to claim 1, characterised in that the film is exposed to a temperature from 85° to 135° C. by passing it over one or more cooling rollers which are at a temperature from 85° to 135° C.

8. Method according to claim 1, characterised in that the exposure to a temperature from 85° to 135° C. is performed by passing the film through a liquid or a gas, and preferably an inert gas, at a temperature from 85 to 135° C.

9. Method according to claim 1, characterised in that the polyolefin used contains 0.01 to 5% by weight of calcium carbonate

10. Method according to claim 1, characterised in that the polyolefin used contains 0.01 to 5% by weight of a UV-stabiliser

11. Method according to claim 1, characterised in that the polyolefin used contains 0.01 to 5% by weight of an aramide and preferably a polyaramide powder.

12. Method according to claim 1, characterised in that what is used as a polyolefin of high molecular weight is a polyethylene of high molecular weight having average molecular weights Mw from 80,000 to 500,000 and Mn from 5,000 to 80,000.

13. Method according to at least one of claims 1 to characterised in that what is used as a polyolefin of high molecular weight is a polypropylene of high molecular weight having average molecular weights Mw from 100,000 to 130,000 and Mn from 25,000 to 33,000.

14. Method according to claim 1, characterised in that the film, on leaving the slit die and upstream of the tempering zone, is also fed, for a period of at least one second, directly through a heating zone which is at a temperature from 135° C. to a temperature of the melting point of the polymer being extruded.

15. Method according to claim 1, characterised in that a bimodal polyolefin is used.

16. Ribbons produced by a method according to claim 1, characterised in that they are of a strength from 500 MPa to 3000 MPa and have a modulus of elasticity from 20 GPa to 180 GPa, the modulus of elasticity being determined from the secant which intersects the stress-strain curve of the ribbon, measured at an ambient temperature of 23° C. and a relative humidity of 65%, at a strain of between 0.5% and 1%.

17. Method of producing textile or engineering sheet materials which contain fine ribbons according to claim 1, characterised in that the ribbons are provided on one or more sides with an adhesive and/or an adhesion promoter and are then connected by lamination to form sheet materials having two or more layers.

18. Method of producing the sheet materials according to claim 17, characterised in that the ribbons are processed into the multilayered sheet materials as laid scrims or woven fabrics.

19. Sheet material according to claim 17, characterised in that the laid scrims or woven fabrics are laminated to one another in such a way that the individual layers of the sheet materials are constructed in such a way that the directions of stretch of the films or ribbons comprising them are at an angle of at least 10° to the directions of stretch of the ribbons in the woven fabrics or laid scrims situated above them or below them.

20. Use of the laminates according to claim 19 for producing protective bodies for providing protection against ballistic projectiles, characterised in that the laid scrims or woven fabrics are used in plate-like or flexible composite bodies.
